(19) United States
(12) Patent Application Publication
(10) Pub. No.: US 2021/0221338 A1
(43) Pub. Date: Jul. 22, 2021

(54) Automated Pedal Depression Apparatus

(71) Applicant: AV Manufacturing LLC, Loveland, CO (US)

(72) Inventor: Lars Anderson, Loveland, CO (US)

(21) Appl. No.: 16/749,667

(22) Filed: Jan. 22, 2020

(51) Int. Cl. B60S 5/00; F16H 21/16

(52) U.S. Cl. CPC B60S 5/00; B60K 23/02; F16H 21/16

(57) ABSTRACT

In particular embodiments of the inventive technology, an automated pedal depression apparatus may comprise a pedal depressor configured to contact a foot pedal for at least some time during operation of the automated pedal depression apparatus; an actuator configured to actuate the pedal depressor; a controller configured to control the actuator; an adjustable support that supports the actuator; a power input configured to receive power for use by the actuator; and actuator motion information communication componentry configured to communicate information to the controller about an actuator motion that is appropriate for an application. Certain embodiments may provide feedback related componentry to facilitate achievement of actuator (and thus pedal depressor) motion as desired, e.g., that which results in engine operation within an RPM range.

### BACKGROUND OF THE INVENTION

New treatments now exist for automobiles that increase efficiency and power; such treatments, whether engine additive or other, may require the engine to be running and, in certain applications, the engine RPM's be increased at predetermined intervals. With currently available technology, the automotive technician must manually control engine operation, e.g., must manually increase the engine RPM's, either by sitting in the seat and depressing the pedal with his/her foot or via some other manual action. The technician must remember to, e.g., accelerate at the precise time over and over again. This is not only inefficient, but also error prone in that it presents a very high risk that at least some if not many of the changes to engine operation (e.g., depress accelerator pedal at certain times during certain interval(s) to achieve a certain engine speed (or other procedural requirements)) will be missed, perhaps due to human forgetfulness or inadvertent negligence (e.g., failing to depress the pedal at the specified time).

Due to these issues many of these treatments are not being administered at all, or are administered improperly, and companies that produce these treatments are not realizing the potential earnings, and apparatus (e.g., engines) that would benefit from a certain treatment might not be receiving such benefit. Embodiments of the inventive technology offer an apparatus that can be used (in certain embodiments) to increase the RPM's at the required interval (e.g., to 2000 RPM from 0 min. to 1 min., to 2500 until 1.5 min, etc.) then autonomously (automatically), and thereby increase the odds that the treatment is accomplished at the proper specifications. Because the inventive apparatus, during operation, is user-independent, the technician could accomplish other tasks at the same time of administration of a treatment, for example, making, that technician more profitable and efficient, as some of these treatment's administration can take upwards of 30 minutes to accomplish.

The inventive automated pedal depression apparatus, in particular embodiments, facilitates performance product administration, engine maintenance, emission testing and long duration maintenance, such as is required on gas, hybrid, perhaps electric, even diesel engines (diesels may require a test duration of 30 minutes or longer). The apparatus, in certain embodiments, supports any application that requires the pedal (e.g., accelerator, brake or clutch) to be depressed, including but not limited to fuel intake maintenance, brake bleeding, throttle adaptation, and clutch adjustment. Another exemplary application includes automated depression (e.g., of a pedal) to achieve, e.g., required engine RPM, for key fob initialization, programming of immobilizer keys, or the like.

### BRIEF DESCRIPTION OF THE FIGURES

FIG. 1 shows a side view of an embodiment of the inventive technology.

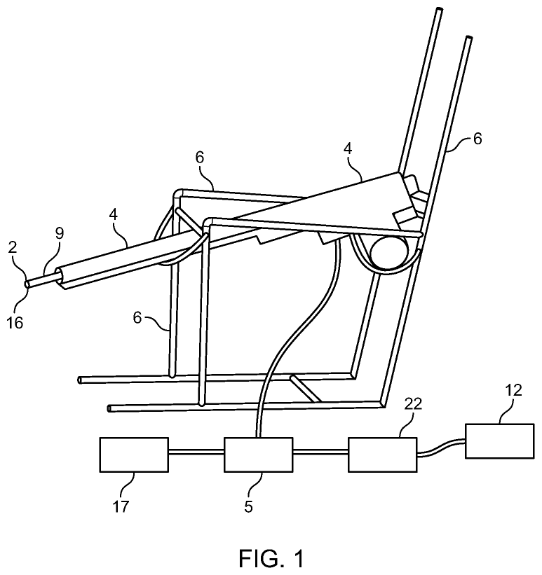

FIG. 2 shows a side view of an embodiment of the inventive technology.

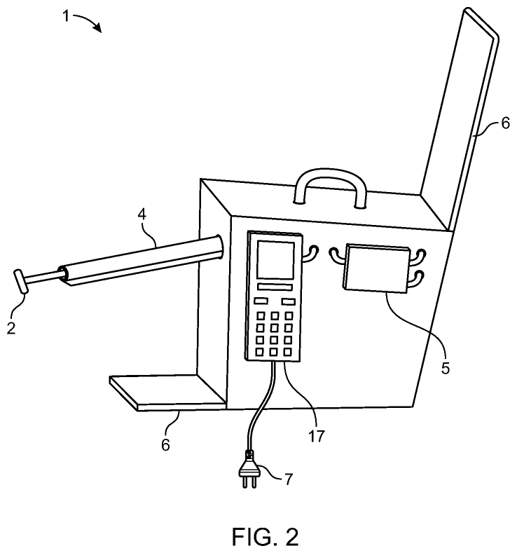

FIG. 3 shows a side view of an embodiment of the inventive technology in a selected position of the adjustable support.

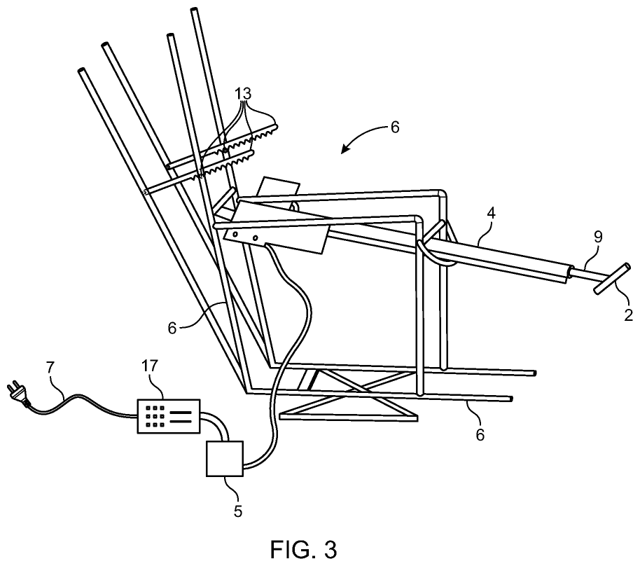

FIG. 4 shows a side view of an embodiment of the inventive technology as established in the driver side floor well of a vehicle.

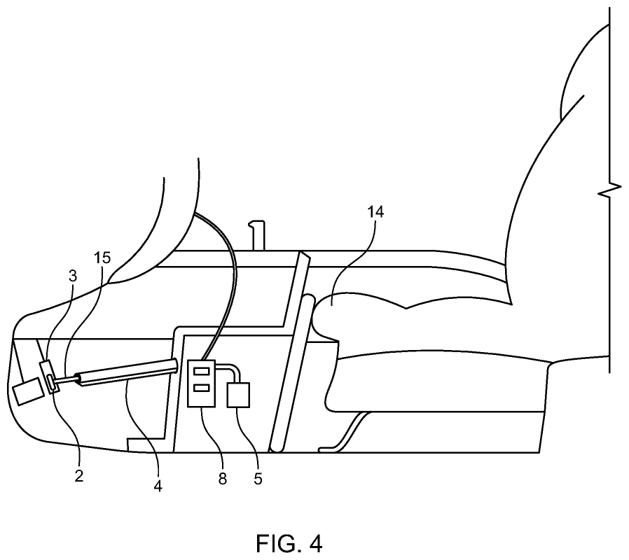

FIG. 5 shows a side view of an embodiment of the inventive technology as established in the driver side floor well of a vehicle; it shows a throttle cable extending from the pedal.

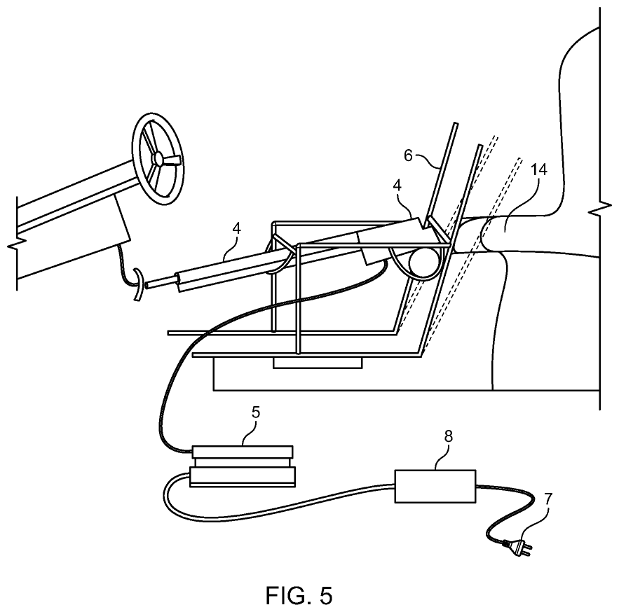

FIG. 6 shows, conceptually, the inter-relationship between various components/elements of the apparatus, in at least one embodiment of the invention. While solid lines can represent flow of data, power, and electrical connections generally, dashed lines are used to portray flow of data in particular (while not excluding other connections between two components/elements).

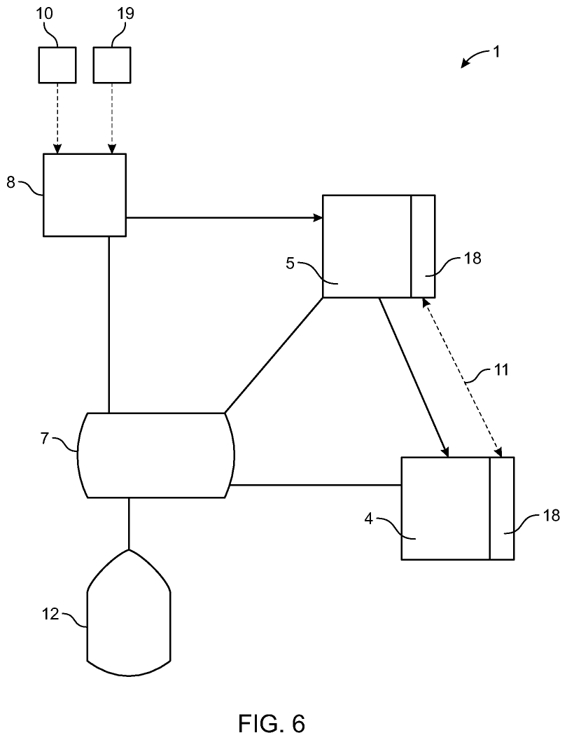

### DESCRIPTION OF THE PREFERRED EMBODIMENTS

It should be understood that the present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

Embodiments of the inventive technology may be described as an automated pedal depression apparatus 1 that comprises: a pedal depressor 2 configured to contact a foot pedal 3 for at least some time during operation of the automated pedal depression apparatus; an actuator 4 configured to actuate the pedal depressor; a controller 5 configured to control the actuator; an adjustable support 6 that supports the actuator; a power input 7 configured to receive power for use by the actuator; and actuator motion information communication componentry 8 configured to communicate information to the controller 5 about actuator motion that is appropriate for (i.e., compliant with) an application (e.g., a certain test or treatment that one desires be conducted).

The pedal depressor 2 is that structural, typically rigid component that contacts the pedal 3 during operation of the apparatus (e.g., a movable, automated tool) to depress the pedal. It may attach to the actuator 4, e.g., at the end of a stem, arm, or other structural component 9 that extends from (and forms a part of) the actuator to that pedal contacting component. The pedal depressor 2 may be attached (permanently or removably) to the actuator 4 (including an arm 9 thereof) with, e.g., welding, bolts, fasteners, adhesive, interference fit, and/or magnetically, or otherwise.

The actuator 4 from which the pedal depressor 2 extends. and allows for the retraction of, the pedal depressor (i.e., causes the motion of, typically by moving a component of the actuator itself), and, in the case of an accelerator pedal, may thereby cause throttle adjustment, e.g., via cable movement. The actuator 4, in particular embodiments, may extend to an extended position 15 (i.e., any position other than a fully retracted position 16) to depress, with the pedal depressor, the vehicle pedal, and then retract to, e.g., a fully retracted position 16, to allow the return of the pedal. This may be repeated cyclically (although repetition is not necessary), where different cycles (each perhaps with a different interval) exhibit the same or different motion vs. time behavior. A cycle may end and begin at full retraction (including whatever retraction results in non-depression of the pedal); an interval may end and begin with the beginning and end of a certain motion (e.g., a slow, linear increase of depression to create a slow, a constant extent of depression for a certain amount of time to achieve a certain RPM for that certain amount of time). Any sort of motion, over any sort of time, can be achieved by particular embodiments of the inventive technology. The actuator 4 may comprise, e.g., an electric motor, servomotor, linear actuator, rotary actuator, robotic actuator, stepper motor, etc.

The actuator 4 may be considered as including merely that componentry that merely follows commands sent to it by the controller 5 that controls it. For example, the controller 5 may be programmed for a specific application to cause the actuator 4 to actuate the pedal depressor 2 to extend a certain distance (from a retracted position) over a certain length of time, stay extended for a certain length of time (before again retracting), and/or extend repeatedly (during a plurality of cycles) at a certain frequency (as but a few temporal/dimensional actuation features that can be specifically set for an application). Any conceivable motion vs. time—whether linear, constant, increasing, decreasing, mixed, curved, etc.—can be achieved by certain embodiments of the inventive technology. When there is more than one interval (which may even occur during one cycle), intervals may exhibit different lengths (e.g., one may be two minutes, another three, etc.), different RPM's, etc., although this is not required.

The controller 5 may electrically process input (e.g., sent by the actuator motion information communication componentry 8) and then communicate commands, whether digitally, as analog, or otherwise, to the actuator 4, which may be configured to take such commands and follow them to generate the intended, command-compliant motion of the pedal depressor 2. The controller 5 and/or the actuator motion information communication componentry 8 may, in certain embodiments, be configured/programmed to obtain feedback-related information 11 (e.g., as to pressure against the pedal, RPM, interval timing, or other); such information may be processed to generate commands usable by the actuator 4 to adjust features (e.g., temporal and/or dimensional (e.g., length of extension)) of the motion of the actuator (and thus of the motion of the depressor) in order to achieve an intended result (e.g., a certain pedal pressure, an RPM within a specific range).

The controller 5, like other components of the apparatus 1 (e.g., information communication componentry), may include a microprocessor and/or PLC in order to carry out (i.e., cause the actuator to move as appropriate for a certain application) the motion-related information communicated to it. Where necessary, the controller 5 may, in certain embodiments, take information communicated to it and transform it into a form that can be acted upon by the actuator 4. In certain embodiments, the controller 5 is programmable to cause the actuator 4 to extend and retract at programmed lengths and/or at programmed intervals (perhaps characterized by programmed speeds, RPM's, accelerations, etc.). In certain embodiments, the controller 5 may come as part of an as-purchased actuator. In fact, one as-purchased device may include the controller 5 and the actuator motion information communication componentry 8 . . . and possibly also the actuator 4.

The actuator motion information communication componentry 8 is that componentry that allows for communication of information regarding a desired actuator motion (e.g., the actuator motion that is appropriate for a particular application) to the controller. It may include wired or wireless communication componentry, interface such as may include port(s), keypad(s), knob(s), button(s), screen(s), slot(s), card reader(s), barcode reader(s), etc. The information may relate to a feature(s) (e.g., temporal and/or dimensional) of such motion or motion protocol (e.g., stroke length, frequency of actuator extension, duration of single extension, RPM range, RPM range/function/variation during interval(s), interval length, and/or duration of test, etc.) or a particular motion protocol (e.g., a particular stroke length, frequency of actuator extension, duration of single extension, features of cycles of motion, and/or duration of test) that is appropriate for, e.g., a particular vehicle and/or engine test. Such information includes but is not limited to digital information that is stored on or off board (e.g., downloadable), information on storage media, analog information, and information entered by a user (user provided information 19, where such information is typically not pre-stored, and manually entered by the user). The information generally, whether digital, part of a program, programmed, stored, entered by a user, analog, or otherwise, may be in a form that is usable by a controller to generate the actuator motion associated with that information.

In certain embodiments, a user may select information from a plurality of stored collections of information 10; such selection may be achieved when a user chooses a particular collection of such information (e.g., online or otherwise) that is already created/programmed, perhaps for a specific protocol unique to a certain test and/or vehicle (generally, application). A manufacturer or product software supplier support entity may provide, e.g., a plurality of different pre-programmed depressor motion protocols (on any storage medium, e.g., cards or sticks, or as downloads), each for a particular vehicle and/or test administration (generally, application). As such, the communication componentry 8 can allow for communication of a selected one of such stored protocols to the actuator. Of course, such information need not be pre-prepared (e.g., pre-stored), as it instead could be entered by an operator of the apparatus on site, perhaps for a custom or other application.

In certain embodiments, the communication componentry 8 may include wireless componentry that may achieve communication via known wireless communication protocols and hardware/software (e.g., Bluetooth, any of several known wireless communication protocols). It may instead not include any wireless capability, i.e., it may be entirely wired. Once information is entered via, e.g., an interface, the communication componentry (of which such interface may be a part), can communicate such information to the controller 5. Of course, even wireless communication componentry may include some wired aspects (e.g., transmission and receiving componentry). Communication componentry may include an encoder, PLC, microprocessor, feedback related componentry, etc. As indicated, the communication componentry 8 may include a user interface 17 enabling entry of application-specific features of motion of the actuator 4 to be communicated to and acted on by the controller 5.

In certain embodiments, the controller 5 (and perhaps the actuator motion information communication componentry 8) may include programmable controller card(s), e.g., Arduino card, and/or H bridge card(s), to allow for programming of the actuator (whether via download of saved instructions/information, entry of user-generated instructions/information, etc.) to extend and retract at desired intervals, to extend at the desired length and speed, to stay extended for desired time, to achieve intended motion over a plurality of cycles, etc. For instance, it may be programmable to extend out 2 inches, stay extended for 1 millisecond, and then return to a fully retracted position and programmable to accomplish this action every 90 seconds for 20 minutes. Interface, as part of an actuator motion information communication componentry, to any controller cards could be via keypad, computer or phone app. These cards can be contained in or detached from the apparatus' (tool) support 6 (e.g., frame).

A user interface 17 may enable application-specific programming of the controller 5 and/or entry of information regarding the temporal/dimensional features of the desired pedal depression by providing any known way for a human operator to enter such information. Such may include, e.g., screen, a keypad, a touch screen, a keypad, dials, switches, knobs, levers, voice-interfacing, card entry slots, data input componentry, etc. The user interface 17 may allow for input, setting and/or adjustment of information regarding temporal and/or dimensional features of the pedal depressor's 2 and/or actuator's 4 motion, whether before or during movement of the pedal depressor or actuator or at other times. One exemplary interface may include buttons, screen(s), knob(s), whether directly on the apparatus, or on a device (e.g., computer or cellphone) that is or can communicate with the controller of the apparatus, whether wirelessly or otherwise. The interface 17 may allow for the entry of information (e.g., frequency and stroke length of the pedal depressor). Indeed, any known way of allowing for user selection of a particular pedal depressor motion feature or protocol (e.g., particular stroke length, time of extension, frequency of extension, number of extensions, etc.) and entry of information regarding that feature or protocol is a user interface. The user interface, in certain embodiments, may even allow for operator adjustment of motion (whether of temporal and/or dimensional features thereof) in response to feedback regarding a sense-able (e.g., electrically) parameter (e.g., pedal pressure, RPM), to achieve the desired motion.

Certain embodiments may involve the provision of feedback-related capability to, e.g., obtain feedback information 11 and possibly provide that information to a user and/or automatically adjust in response to that feedback. For example, perhaps it is desired that the pedal depressor depresses the pedal with a pressure, or causes an engine RPM that is within a certain range; in such case, feedback information 11 regarding such pressure or RPM may be forwarded to a user so that such user can adjust a feature of the motion of the depressor so that it acts with an in-range pressure/RPM, or it can be used by componentry that automatically effects such adjustment. The controller 5 and/or the actuator motion information communication componentry 8 may include feedback related componentry 18; it may, like other componentry, include a PLC and/or a microprocessor.

Generally, any interface 17 allowing user entry, including programming, input/downloading, etc., of information (not previously stored, or stored) regarding an intended motion protocol of the apparatus, as discussed elsewhere herein, can manifest via any one or more of several modes, software programs, keypads, bluetooth applications, phone apps, inter cilia.

In certain embodiments, the actuator 4 can also be manually manipulated to extend and retract to any position at the discretion of the operator. Such manual extension by a human operator can be used to extend the actuator to any desired length and keep it extended for any desired amount of time. Manual manipulation of the actuator can be by remote control or a hard-wired communication componentry/interface; either may be considered part of the actuator motion information communication componentry 8 (which may, instead of or in addition to facilitating manual manipulation, facilitate, e.g., pre-programmed information). Relatedly, certain embodiments may offer a switch (e.g., an AB switch) that can allow switching between programmable (or more generally, fully automated) operation mode to a manual operation mode.

Of course, a power input 7, whether an inlet for electrical power, (including but not limited to grid, battery, solar, geothermal, wind), or otherwise, may allow for the provision of power to any components of the apparatus, e.g., the actuator, the controller, communication componentry, and/or user interface, that require power. And of course, even where the power supply is on-board (e.g., an on-board battery(ies)), the apparatus is still considered as having a power input (it would be the componentry that enables conveyance of power from a source such as the AC grid or battery(ies)). A power input (accepting power from a power source) is needed to supply power to certain components (e.g., the actuator, at the least). Input power may, but need not, be regulated or conditioned by a power regulator/conditioner 22.

In certain embodiments (e.g., battery embodiments), a power source 12 can be (but need not be) contained within in or detached from the support. In certain embodiments, power may be supplied by an outlet in the automobile, possibly alleviating the necessity of having an additional piece of hardware to power the apparatus, thereby providing additional operational convenience.

The adjustable support 6 that supports the actuator 4 may retain the actuator 4 (or perhaps the main body thereof), and perhaps also the controller 5, communication componentry 8, and/or user interface 17 (if they're disposed onboard), in sufficiently/substantially fixed relation to vehicle parts other than the pedal or moving parts of the actuator (during operation of the apparatus to move that pedal). Such relatively immobile retention of position of such componentry may allow for a more precise impartation of motion by the actuator to the pedal depressor 2, and thus to the pedal. The support may include, but is not limited to, any one or more of the following: rigid (e.g., metal or plastic or other sufficiently rigid material) support members, a frame, struts, rigid blocks, shaped mass, etc.

The support 6 may be adjustable, (perhaps even compressible in certain embodiments), to accommodate different dimensions of the general driver-side foot space (including the space defined by the floorboard, the front of the driver-side seat, and/or the pedal(s) 3 (particularly the accelerator pedal)). Adjustability may be provided by any known adjustment componentry 13, which may include but is not limited to: holes and bolts in support members, Velcro™, straps, buckles, button locks, telescoping member locks, a plurality of selectable notches in support members, extendable members that are lockable in any of a plurality of different lengths, and elastically compressible masses (e.g., slightly compressible, elastic foam supports that allow the apparatus to be fit into any of a variety of spaces (after compression to fit into a space between the pedal and the seat, an elastic response may provide the needed substantially fixed positioning/retention of the apparatus)). Adjustability allows for the use of a single apparatus (or one of a few differently sized apparatus) in a variety of different applications (e.g., use of one apparatus in more than one vehicle).

In certain embodiments, the support 6 (e.g., a frame or mount) supports the actuator 4, a programmable controller 5 and the power supply, and may be adjustable to fit any of several vehicles. It may be positioned between the vehicle seat 14 and pedal, resting on the vehicle floor. It may be a mounted, rigid and adjustable frame. It is of note that various componentry, e.g., the user interface 17, controller 5, etc., may be onboard, or offboard (e.g., where it is not within or attached to the support) of the apparatus. Typically, the actuator 4 and the pedal depressor 2 would be onboard.

The support 6 (e.g., a frame) may be made of rigid material and be (removably) rested on the drivers' side floor of the vehicle. The support 6 (e.g., frame) may, in certain embodiments, as mentioned, be fully adjustable (fore and aft, and height). The back and the base of the frame (or other support) may be adjustable to fit any configuration of vehicle seat 14 or floor to ensure the tool (apparatus) rests solidly against the driver's seat and to rest level on the floor. The support 6 may also be adjustable for height to ensure the pedal depressor 2 attached to the actuator 4 aligns with the desired pedal 3, and can extend (and retract) sufficiently to depress the pedal 3 as required. The support 6, particularly when it is a frame, can be made of any rigid material, e.g., aluminum, steel, plastic, etc.; it could be 3D printed or manufactured using any other known techniques. Note that a support is considered adjustable even where only a portion of that support allows for adjustment.

The actuator 4 may be disposed within the support 6 and may extend the pedal depressor 2 so that it can make contact and depress the vehicle accelerator, brake or clutch foot pedal 3. In certain embodiments, the pedal depressor 2 itself does not need to hook to or be fastened to the pedal 3 (as the actuator 4 rests in a support on the floor of the vehicle between the seat 14 and the pedal 3 and moves the pedal depressor 2). A vehicle seat 14 (a broad term that includes the seat or seat frame) may provide at least a degree of stability for the apparatus when it extends and makes contact with the pedal 3; more particularly, in certain embodiments, the actuator moves the pedal depressor 2 so that it depresses the pedal 3 and the seat 14 stops the apparatus 1 from moving backwards as pressure is applied to the pedal 3. Even where the height of the actuator 4 is adjustable in the support 6 (e.g., frame), the support is considered adjustable. The support 6 may be adjustable to change the height of the actuator 4, to accommodate various pedal configurations. The actuator 4 may come in, or provide for, varying lengths of strokes; the pedal depressor 2 may come in varying sizes. The actuator 4, in particular embodiments, fits in the support and, in conjunction with the pedal depressor 2, is long enough to extend to the desired length to depress the pedal 3. It needs to generate enough pressure to sufficiently depress the pedal 3 as appropriate for an application.

Certain embodiments of the inventive technology may be described as a pedal depression automation method, and may include the following steps: configuring (e.g., designing and/or manufacturing) a pedal depressor to contact a foot pedal; configuring an actuator to actuate (e.g., move linearly, such as forward and back) said pedal depressor; configuring a controller to control said actuator; configuring a support to support said actuator; configuring a power input to receive power for use by said actuator; and configuring actuator motion information communication componentry to communicate information to the controller about an actuator motion that is appropriate for an application. Any apparatus features indicated in the remainder of this application can serve as support for steps, e.g., “configuring said feature . . . .” Another set of embodiments of the inventive technology may be described as a pedal depression automation method and may focus on steps performed by the apparatus itself, e.g., a pedal depression automation method comprising the steps of: contacting a foot pedal with a pedal depressor of an automated pedal depression apparatus, for at least some time during operation of said automated pedal depression apparatus; actuating said pedal depressor with an actuator; controlling said actuator with a controller; adjustably supporting said actuator; receiving, with a power input, a power for use by the actuator; and communicating, with actuator motion information communication componentry, information to the controller about an actuator motion that is appropriate for an application. Additional method steps may relate to steps performed by any of the apparatus componentry described herein.

Additional Information: As can be easily understood from the foregoing, the basic concepts of the present invention may be embodied in a variety of ways. It involves both motion control techniques as well as devices to accomplish the appropriate motion control. In this application, the motion control techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words, if not given a different, specific definition herein, are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. For example, to the extent ultimately used, the existence or non-existence of a substance or condition in a particular input, output, or at a particular stage can be specified as substantially only x or substantially free of x, as a value of about x, or such other similar language. Using percentage values as one example, these types of terms should be understood as encompassing the options of percentage values that include 99.5%, 99%, 97%, 95%, 92% or even 90% of the specified value or relative condition; correspondingly for values at the other end of the spectrum (e.g., substantially free of x, these should be understood as encompassing the options of percentage values that include not more than 0.5%, 1%, 3%, 5%, 8% or even 10% of the specified value or relative condition, all whether by volume or by weight as either may be specified). In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of an “actuator” should be understood to encompass disclosure of the act of “actuating”—whether explicitly discussed or not—and, conversely, were there effectively disclosure of the act of “actuating”, such a disclosure should be understood to encompass disclosure of an “actuator” and even a “means for actuating” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the automated motion control devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

In addition and as to computer aspects and each aspect amenable to programming or other electronic automation, it should be understood that in characterizing these and all other aspects of the invention—whether characterized as a device, a capability, an element, or otherwise, because all of these can be implemented via software, hardware, or even firmware structures as set up for a general purpose computer, a programmed chip or chipset, an ASIC, application specific controller, subroutine, or other known programmable or circuit specific structure—it should be understood that all such aspects are at least defined by structures including, as person of ordinary skill in the art would well recognize: hardware circuitry, firmware, programmed application specific components, and even a general purpose computer programmed to accomplish the identified aspect. For such items implemented by programmable features, the applicant(s) should be understood to have support to claim and make a statement of invention to at least: xv) processes performed with the aid of or on a computer, machine, or computing machine as described throughout the above discussion, xvi) a programmable apparatus as described throughout the above discussion, xvii) a computer readable memory encoded with data to direct a computer comprising means or elements which function as described throughout the above discussion, xviii) a computer, machine, or computing machine configured as herein disclosed and described, xix) individual or combined subroutines and programs as herein disclosed and described, xx) a carrier medium carrying computer readable code for control of a computer to carry out separately each and every individual and combined method described herein or in any claim, xxi) a computer program to perform separately each and every individual and combined method disclosed, xxii) a computer program containing all and each combination of means for performing each and every individual and combined step disclosed, xxiii) a storage medium storing each computer program disclosed, xxiv) a signal carrying a computer program disclosed, xxv) a processor executing instructions that act to achieve the steps and activities detailed, xxvi) circuitry configurations (including configurations of transistors, gates, and the like) that act to sequence and/or cause actions as detailed, xxvii) computer readable medium(s) storing instructions to execute the steps and cause activities detailed,

xxviii) the related methods disclosed and described, xxix) similar, equivalent, and even implicit variations of each of these systems and methods, xxx) those alternative designs which accomplish each of the functions shown as are disclosed and described, xxxi) those alternative designs and methods which accomplish each of the functions shown as are implicit to accomplish that which is disclosed and described, xxxii) each feature, component, and step shown as separate and independent inventions, and xxxiii) the various combinations of each of the above and of any aspect, all without limiting other aspects in addition.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. An automated pedal depression apparatus comprising:
a pedal depressor configured to contact a foot pedal for at least some time during operation of said automated pedal depression apparatus;
an actuator configured to actuate said pedal depressor;
a controller configured to control said actuator;
an adjustable support that supports said actuator;
a power input configured to receive power for use by said actuator; and
actuator motion information communication componentry configured to communicate information to the controller about an actuator motion that is appropriate for an application.

2. The automated pedal depression apparatus as described in claim 1 wherein said foot pedal comprises a pedal selected from the group consisting of accelerator pedal, brake pedal, and clutch pedal.

3. The automated pedal depression apparatus as described in claim 1 wherein said actuator comprises an actuator selected from the group consisting of electromotor actuator, servomotor actuator, linear actuator, rotatory actuator, robotic actuator, and stepper motor actuator.

4. The automated pedal depression apparatus as described in claim 1 wherein said actuator comprises an extendable actuator arm.

5. The automated pedal depression apparatus as described in claim 4 wherein said pedal depressor is established at the end of said extendable actuator arm.

6. The automated pedal depression apparatus as described in claim 1 wherein said controller comprises feedback related componentry.

7. The automated pedal depression apparatus as described in claim 1 comprises a digital controller.

8. The automated pedal depression apparatus as described in claim 1 wherein said controller is configured to control said actuator according to pre-programmed information.

9. The automated pedal depression apparatus as described in claim 1 wherein said controller is configured to control said actuator according to user-entered information.

10. The automated pedal depression apparatus as described in claim 1 wherein said adjustable support comprises a frame.

11. The automated pedal depression apparatus as described in claim 1 wherein said adjustable support is configured for establishment between a vehicle seat and said foot pedal.

12. The automated pedal depression apparatus as described in claim 1 wherein said power input comprises a grid-power power input.

13. The automated pedal depression apparatus as described in claim 1 comprises a battery power power input.

14. The automated pedal depression apparatus as described in claim 1 wherein said actuator motion information communication componentry comprises a user interface.

15. The automated pedal depression apparatus as described in claim 1 wherein said actuator motion information communication componentry communicates information entered by a user.

16. The automated pedal depression apparatus as described in claim 1 wherein said actuator motion information communication componentry communicates pre-programmed information.

17. The automated pedal depression apparatus as described in claim 1 wherein said actuator motion information communication componentry comprises stored information.

18. The automated pedal depression apparatus as described in claim 1 wherein said apparatus, during operation, allows for user-independent administration of an engine treatment.

19. The automated pedal depression apparatus as described in claim 1 wherein said adjustable support, during operation of said apparatus, is itself supported by a vehicle floor and a vehicle seat.

20. The automated pedal depression apparatus as described in claim 1 wherein said actuator comprises feedback related componentry.
